(19) United States
(12) Patent Application Publication
(10) Pub. No.: US 2024/0365701 A1
(43) Pub. Date: Nov. 7, 2024

(54) Method and apparatus for systematized cultivation of grain crops

(71) Applicant: Ruey-Hsiung HSU, Taipei City (TW)

(72) Inventor: Ruey-Hsiung HSU, Taipei City (TW)

(21) Appl. No.: 18/612,126

(22) Filed: Mar. 21, 2024

(30) Foreign Application Priority Data
Mar. 23, 2023 (TW) 112110935

(51) Int. Cl. A01C 7/06; A01C 21/00; A01G 22/22

(52) U.S. Cl. CPC A01C 7/06; A01C 21/005; A01G 22/22

(57) ABSTRACT

A method and an apparatus for systematized cultivation of grain crops are disclosed involve a conveying unit, a sowing unit, a seedling-growing/warehousing unit, an irrigating/draining/fertilizing unit, a canopying unit, a harvesting unit, a soil treating unit, and a liquid-fertilizer fermenting unit. The conveying unit conveys culture boxes in a cyclic process to distribute plants in the seedling-growing/warehousing unit and the irrigating/draining/fertilizing unit for cultivation. The culture boxes cultivating plants related to other system operations not corresponding to the growth period are conveyed to other areas through the cyclic process. Since operations in the seedling-growing/warehousing unit and the irrigating/draining/fertilizing unit corresponding to the growth period and the other system operations for the grain crops are conducted simultaneously and synchronously, the grain crops can be continuously, cyclically fed into the cultivation system for seedling and growth until they can be harvested, so as to increase harvests per year and the overall yield.

### BACKGROUND OF THE INVENTION

### 1. Technical Field

The present invention relates to a method and an apparatus for systematized cultivation of grain crops more particularly, the present invention relates to a method for cultivating and harvesting grain crops in a systematized way so as to increase the number of harvests per unit time and a system that implements the method.

### 2. Description of Related Art

Traditionally, agriculture, especially farming of paddy, millet, oats, wheat, corn, sorghum, Job's tears, etc., is highly dependent on the climate, and working hard does not necessarily bring about rewards. For example, although many research institutes in Taiwan have long been dedicated to teaching people how to farm grain crops and use pesticides better, farming is still a less attractive livelihood because these techniques may turn out to be in vain if unluckily farmers do not have good weather in the growth period of their crops. Besides, while organic agriculture and produce traceability seem to rage on the market, traditional farming practices still make their outcomes limited by the weather. This is thus evident that agriculture indeed needs some breakthrough.

On the other hand, people in the third decade of the 21^{st} century have faced challenges from the epidemic, climate change, and even wars. It is again the moment for human to fight for our subsistence. There is an old saying, bread is the staff of life. Food safety has thus in the time of difficulties become the top priority for governments all over the world. However, according to the United Nations World Food Program, up to 828 million people go to bed hungry every night, and 345 million people face starvation worldwide. Is seems more than difficult to satisfy the “need for food” of people all over the world with the existing agricultural practices.

Taiwan is located at the border between the torrid zone and the subtropical zone and surrounded by sea, while enjoying the moderate climate. In days when the weather is favorable, three plentiful harvests of rice per year can be expected. However, growth of rice is highly dependent on sunlight and water. The conventional farming solution that has soil preparation, fertilization, seedling transplant, growth, and harvest performed in the same field has its limitation in further increasing harvests. The inventors of the present invention thus have contemplated introducing systematization into the agricultural industry by using a refined partitioning strategy to allow operations throughout production of grain crops, from seedling growth to harvest, to be performed synchronously, and believe that a doubled yield is thereby expectable.

### SUMMARY OF THE INVENTION

The main concept of the present invention is to separate plant-growing operations from the other operations in cultivation of grain crops, such as soil treatment, fertilization, and harvest, and allow the two types of operations to be performed simultaneously and synchronously at different locations, so as to address the shortcomings of conventional cultivation that needs a large whole piece of land to conduct successive farming operations in a temporal order and leaves growing-related operations that directly contribute to production of grain crops crowded out by those non-growth operations in terms of time and space. The present invention ensures production of grain crops using a robust, cyclical system wherein operations directly related to plant growth and operations not directly related to plant growth, such as oil treatment, fertilization, and harvest, can be conducted simultaneously and synchronously at different locations. This prevents non not growth-critical operations from overshadowing or interfering with growth of grain crops and saves all time and days particularly favorable at a given place for growth of grain crops, so as to significantly increase time that can be used as the growth period per unit time (e.g., per year), and make a doubled or even redoubled yield expectable.

To meet the need described above, the present invention provides a method and an apparatus for systematized cultivation of grain crops, which involves performing cultivation and harvest of the grain crops on plural culture boxes as a set. The method comprises: operation of a conveying unit (automated), which involves using conveying tracks to cyclically convey the culture boxes and using a plurality of wagons (automated) to transfer the culture boxes; operation of a sowing unit, which involves feeding the culture boxes that are in an initial state to the apparatus at an input end of the first conveying track, wherein the culture boxes each contain culture soil that has been fertilized but has not been sowed, and sowing the culture soil in the culture boxes with seeds of the grain crops so as to enter the culture boxes into a prepared state; operation of a seedling-growing/warehousing unit, which involves providing a storage rack that defines therein a plurality of storage spaces, using a lifting-type wagon (automated) to move the culture boxes that are in the prepared state and on the first conveying track to the storage spaces, respectively, for storage and cultivation thereby accomplishing germination and seedling-growing of the grain crops, so as to enter the culture boxes into a seedling state, and using the lifting-type wagon (automated) to send the culture boxes that have stored in the storage spaces for a seedling-growing period and are in the seedling state back to the first conveying track; operation of an irrigating/draining/fertilizing unit, which involves providing a cyclical conveying track in a space where sunlight sufficient to growth of the grain crops is available, using a traversing-type wagon (automated) to send the culture boxes in the seedling state from the first conveying track to the cyclical conveying track for cyclical conveyance, using a watering/fertilizing device for watering and fertilization so as to support the grain crops during a growth period of the grain crops so as to enter the culture boxes in a ripe state upon expiration of the growth period; and using the traversing-type wagon (automated) to send the culture boxes that are in the ripe state and have been cyclically conveyed on the cyclical conveying track back to the first conveying track; and operation of a harvesting unit, wherein the harvesting unit is located at a joint between the first conveying track and a second conveying track downstream the irrigating/draining/fertilizing unit, and the operation involves tilting the culture boxes in the ripe state against the first conveying track to a side, removing grains from stems of the ripe grain crops, placing the culture boxes now in a harvested state onto the second conveying track, and moving the culture boxes toward the input end of the first conveying track, and optionally, during the back sending processing, operation of a soil treating unit, involving ripping the culture soil, removing roots of the grain crops and weeds from the culture soil, sterilizing and fertilizing the culture soil in the culture boxes that are in the harvested state and come from the second conveying track, so as to renew the culture boxes into the initial state, and transferring the culture boxes in the initial state to the input end of the first conveying track, for cyclically returning them to the operation of the conveying unit (automated).

The present invention as disclosed previously may further comprise operation of a canopying unit, which involves using a rain cover that spreads over the cyclical conveying track to protect the grain crops from a direct rain hit during heavy rain.

The present invention as disclosed previously may further involve a liquid-fertilizer fermenting unit, which shatters stems and leaves cut off from the grain crops by the harvesting unit and the roots of the grain crops and weeds removed by the soil treating unit operation into fine pieces, and ferments the fine pieces to produce a liquid fertilizer to finally provide the liquid fertilizer for the soil treating unit operation and the irrigating/draining/fertilizing unit operation to use.

In the present invention as disclosed previously, each of the culture boxes has a bottom whose two sides are each provided with an underlaying square tube, and three said culture boxes are gathered as a set to be placed on a square base plate to be moved.

In the present invention as disclosed previously, the first conveying track and the second conveying track may comprise a plurality of column-like rollers parallel to each other. The column-like rollers roll to drive the square base plates to move.

In the present invention as disclosed previously, the culture boxes are moved between the conveying tracks and the wagons (automated) by a mobile crane.

In the present invention as disclosed previously, a drain hole is located between the two underlaying square tubes of each culture box. The drain hole is removably plugged and sealed by a drain stopper below the culture box. The cyclical conveying track comprises a plurality of column-like rollers parallel to each other. The column-like rollers roll and drive the culture box to move. A drainage controller is installed among the column-like rollers. The drainage controller uses an extendable crook to detachably connect the drain stopper. By removing the drain stopper, water in the culture box is allowed to drain downward.

In the present invention as disclosed previously, the sowing unit further comprises: a leveler, which uses a first robotic arm to control a leveling board to traverse across the fertilized and not sowed culture soil in the culture boxes on the first conveying track, so as to level the surface of the soil; a grain depot, which is used to store the seeds of the grain crops; a broadcaster, which is installed downstream the leveler in an advancing direction of the first conveying track, and has a plurality of low-pressure suction tubes arranged into an array, wherein each of the low-pressure suction tubes draws a said seed of the grain crops with a negative pressure, and ejects the seed when negative pressure is replaced by a positive pressure; a second robotic arm, which is connected to the broadcaster top control the broadcaster to move between the grain depot and the culture boxes, so that the broadcaster broadcast the seeds of the grain crops at predetermined locations in the culture boxes; a coverer, which is installed downstream the broadcaster in the advancing direction of the first conveying track, and serves to cover the seeds broadcasted in the culture boxes with the culture soil; and a waterer, which is installed downstream the coverer in the advancing direction of the first conveying track, and serves to apply water into the culture boxes to keep the culture soil humid.

In the present invention as disclosed previously, the seedling-growing/warehousing unit further comprises a sprayer configured to stretch into each of the storage spaces to water the culture boxes stored in the storage spaces so as to satisfy a minimum water requirement that supports a seedling-growing activity of the grain crops.

In the present invention as disclosed previously, the watering/fertilizing device further comprises: a fertilizing module, comprising: a liquid-fertilizer storage tank, for storing a liquid fertilizer; a first water-pumping motor; a first pipe, which is connected to the first water-pumping motor, so that the first water-pumping motor activates to pump a liquid fertilizer stored in the liquid-fertilizer storage tank into the first pipe; and a plurality of liquid-fertilizer nozzles, which are connected to the first pipe for spraying the liquid fertilizer; a water-spraying module, which comprises: a clean-water tank, for storing clean water; a second water-pumping motor; a second pipe, which is connected to the second water-pumping motor, so that the second water-pumping motor activates to pump clean water in the clean-water tank into the second pipe; and a plurality of clean-water nozzles, which are connected to the second pipe for spraying the clean water; a fixed frame, which has an upper shelf and a lower shelf, so that the liquid-fertilizer nozzles are arranged along the upper shelf, and the clean-water nozzles are arranged along the lower shelf; and a displacer, which carries the fixed frame and is located at one end of the cyclical conveying track, so that when a said culture box is delivered to a place in front of the watering/fertilizing device by the cyclical conveying track, the displacer approaches the culture box, and the first water-pumping motor operates to spray the liquid fertilizer over leaves of the grain crops through the liquid-fertilizer nozzles, and the second water-pumping motor operates to spray the clean water to roots of the grain crops through the clean-water nozzles, wherein after the leaves are watered and to soil is fertilized, the displacer returns to a home position thereof, leaving the culture box cyclically moving on the cyclical conveying track.

In the present invention as disclosed previously, the canopying unit further comprises: a plurality of arch-like ribs, which span over the cyclical conveying track; a rain-cover roll, which contains a rain cover that is rolled up, wherein the rain cover is normally rolled up and is unrolled to slidably spread over the arch-like ribs when receiving an external pulling force, and when the pulling force disappears, the rain-cover roll rolls the rain cover back to enclosure thereof; a guiding steel wire, which has one end thereof tied on a terminal of the rain cover, and is unwound and slidably spreads over the arch-like ribs; and a wire winch, which is connected to an opposite end of the guiding steel wire so as to wind the guiding steel wire and unroll the rain cover.

In the present invention as disclosed previously, the harvesting unit further comprises: a workbench, which is provided with a plurality of balls so that the culture boxes are allowed to slide thereon; a plurality of culture box manipulators, for cyclically operating on the workbench, wherein each of the culture box manipulators comprises: a bottom shell; a top plate, which has a projection area in a top-view plane that is equal to a projection area of the bottom shell in the top-view plane, and is slightly larger than a projection area of the culture boxes in the top-view plane, wherein the top plate has an upper plane for carrying a said culture box, and the top plate has a left lateral thereof hinged to one lateral of the bottom shell; a pair of claiming jaws, which are installed at the left lateral and a right lateral of the top plate, respectively, and operatably close to hold the culture box therebetween; and an air cylinder, which has two ends thereof hinged to the right lateral of the top plate and an opposite lateral of the bottom shell, and when operating makes the top plate and the bottom shell rotate with respect to each other against where they are hinged; a machine-controlled arm complex, which comprises a plurality of machine-controlled arms, for moving the culture boxes from the first conveying track to corresponding cultivation box manipulators on the workbench, moving the culture box manipulators to predetermined locations on the workbench, and moving the culture boxes the cultivation box manipulators to the second conveying track; at least one threshing device, which is installed at one side of the workbench, and rotates to remove the grains from the grain crops in the tilted culture box; and a cutter, which is located at the side of the workbench having the at least one threshing device, and serves to cut stems and leaves of the thrashed grain crops. When the claiming jaws clamp the culture box, the air cylinder stretches to rotate the top plate with respect to the bottom shell so as to tilt the culture box. When the grain crops in the culture box have been cut off, the air cylinder retracts to rotate the top plate and lay the top plate on the bottom shell, after which the claiming jaws release the culture box.

In the present invention as disclosed previously, the soil treating unit further comprises: a plurality of soil-ripping/root-removing devices, each comprising: two rotary rakes, each composed of a rotating shaft and a plurality of spikes perpendicularly combined to the rotating shaft; and two controlling motors, each connected to the rotating shaft of a said rotary rake and configured to rotate oppositely and synchronously, so as to pose the two rotary rakes in a contracted state where the spikes are opposite and parallel to each other; in an expanded state where the spikes are parallel to each other and all pointed downward; or a root-removing state where the spikes are staggered with an angular difference that is smaller than or equal to 90 degrees; and a third robotic arm, which is connected to and controls the soil-ripping/root-removing devices to perform following operations: moving the soil-ripping/root-removing devices from a root-removing area to a location over the culture boxes in which the grain crops have been cut off; posing the soil-ripping/root-removing devices into the expanded state, and pressing the soil-ripping/root-removing devices down to the culture soil in the culture boxes; posing the soil-ripping/root-removing devices into the root-removing state, and lifting the soil-ripping/root-removing devices upward so that remaining roots of the grain crops are grasped and held between by the spikes of the two rotary rakes; and moving the soil-ripping/root-removing devices back to a location over the root-removing area, and posing the soil-ripping/root-removing devices into the expanded state again so that the remaining roots of the grain crops fall into the root-removing area.

In the present invention as disclosed previously, the soil treating unit further comprises a steam-based sterilizing/weeding device, which is hung over the second conveying track through a bracket or a ceiling board, and comprises: a plurality of steaming stirring rods, each comprising a first tube and a plurality of steaming/stirring blades fixedly connected to one end of the first tube, wherein each said first tube has a support ring at a middle part thereof and each said steaming/stirring blade defines therein an air-guiding pipe that is communicated with the first tube, so that when the first tube is filled with steam, the steam flows out through the air-guiding pipe; a first transmission box, which encloses an opposite end of each of the first tubes and contains therein a first transmission mechanism and at least one drive motor that drives the first transmission mechanism to operate to rotate the steaming stirring rods synchronously; three fixing plates, each having a profile matching a top opening of a said culture box and being provided with a plurality of round holes, wherein a said first tube is inserted into a said round hole, so that each of the fixing plates is supported by the support rings; a steam generator, which is mounted on the first transmission box and connected to the first tubes through a connecting pipe, and serves to generate and deliver the steam to the first tubes; and a first lifting device, which is connected between the first transmission box and a bracket or a ceiling board for adjusting the first transmission box in altitude. When the three culture boxes are moved to a location below the steam-based sterilizing/weeding device by the second conveying track, the first lifting device lowers the first transmission box in altitude, so that the steaming/stirring blades of the steaming stirring rods insert into the culture soil in the culture boxes in a manner that each of the fixing plate covers the top opening of the corresponding culture box, after which the steam generator and the at least one drive motor start to operate and the steaming stirring rods rotate, so that the steam flowing out of the air-guiding pipes kills bacteria and weeds in the culture soil and accomplishes a sterilization and weeding activity. Upon completion of the sterilization and weeding activity, the steam generator and the at least one drive motor stop, and the first lifting device lifts the first transmission box in altitude, thereby removing the steaming/stirring blades of the steaming stirring rods from the culture soil to allow the culture boxes to resume advancing as the second conveying track is activated.

In the present invention as disclosed previously, the soil treating unit further comprises a liquid-fertilizer applicator, which is hung over the second conveying track through a bracket or a ceiling board, and comprises: a plurality of fertilizer dispensing rod, each comprising a second tube and a plurality of liquid-fertilizer stirring blades fixedly connected to one end of the second tube, wherein each said liquid-fertilizer stirring blade contains therein a liquid-guiding pipe that is communicated with the second tube, so that when the second tube is filled with a liquid fertilizer, the liquid fertilizer flows out through the liquid-guiding pipe; a second transmission box, which enclose an opposite end of each of the second tubes, and the second transmission box contains therein a second transmission mechanism and at least one drive motor that drives the second transmission mechanism to operate to rotate the fertilizer dispensing rods synchronously; a fertilizer dispenser, which is mounted on the second transmission box and is connected to the second tubes through a connecting pipe for delivering the liquid fertilizer to the second tubes; and a second lifting device, which is connected between the second transmission box and a bracket or a ceiling board for adjusting the second transmission box in altitude. When the three culture boxes are moved to a location below the liquid-fertilizer applicator by the second conveying track, the second lifting device lowers the second transmission box in altitude, so that the liquid-fertilizer stirring blades of the fertilizer dispensing rods insert into the culture soil in the culture boxes after which the fertilizer dispenser and the at least one drive motor start to operate and the fertilizer dispensing rods rotate, so that the liquid fertilizer flowing out of the liquid-guiding pipes fertilizes the culture soil and accomplishes a fertilization activity. Upon completion of the fertilization activity, the fertilizer dispenser and the at least one drive motor stop, and the second lifting device lifts the second transmission box in altitude, thereby removing the liquid-fertilizer stirring blades of the fertilizer dispensing rods from the culture soil to allow the culture boxes to resume advancing as the second conveying track is activated.

In the present invention as disclosed previously, the liquid-fertilizer fermenting unit further comprises: a shredder, which shreds stems and leaves of the grain crops cut by the harvesting unit and roots of the grain crops and weeds removed by the soil treating unit into fine pieces; and a plurality of liquid-fertilizer fermenting tanks for storing the fine pieces and fermenting the fine pieces to produce a liquid fertilizer that is delivered to the fertilizer dispenser through a connecting pipe.

### BRIEF DESCRIPTION OF THE DRAWINGS

FIG. 1 is a top view of an apparatus for (systematized) (automated) cultivation and harvesting of grain crops according to one embodiment of the present invention.

FIG. 1A is a flowchart showing operations of the apparatus of FIG. 1.

FIG. 2 is a perspective view of a culture box according to the present invention.

FIG. 3A illustrates the drain hole of the culture box being stopped.

FIG. 3B illustrates the drain hole of the culture box being unstopped.

FIG. 4 illustrates assembly of a first conveying track.

FIG. 5 details the structure of a sowing unit.

FIG. 6A details the structure of a watering/fertilizing device and illustrates its operation.

FIG. 6B details the structure of a watering/fertilizing device and illustrates its operation.

FIG. 7 details the structure of a canopying unit.

FIG. 8A details the structure a workbench and a culture box manipulator that are in operation.

FIG. 8B details the structures a workbench and a culture box manipulator not in operation.

FIG. 9A illustrates the culture box and the manipulator in operation but not combined yet.

FIG. 9B illustrates the culture box and the manipulator operating for thrashing.

FIG. 9C illustrates the culture box and the manipulator operating for crop cutting.

FIG. 9D illustrates the culture box and the manipulator at completion of harvesting.

FIG. 10 is a top view of 6 soil-ripping/root-removing devices.

FIG. 11A through FIG. 11F show different operational aspects of a third robotic arm and a soil-ripping/root-removing device.

FIG. 12A through FIG. 12B show different use aspects of a steam-based sterilizing/weeding device.

FIG. 13 illustrates the external structure of a steaming stirring rod.

FIG. 14 is a cross-sectional view of a first transmission box.

FIG. 15 is a cross-sectional view of a liquid-fertilizer applicator.

FIG. 16 illustrates the external structure of a fertilizer dispensing rod.

### DETAILED DESCRIPTION OF THE INVENTION

The present invention will be further explained by embodiments described below.

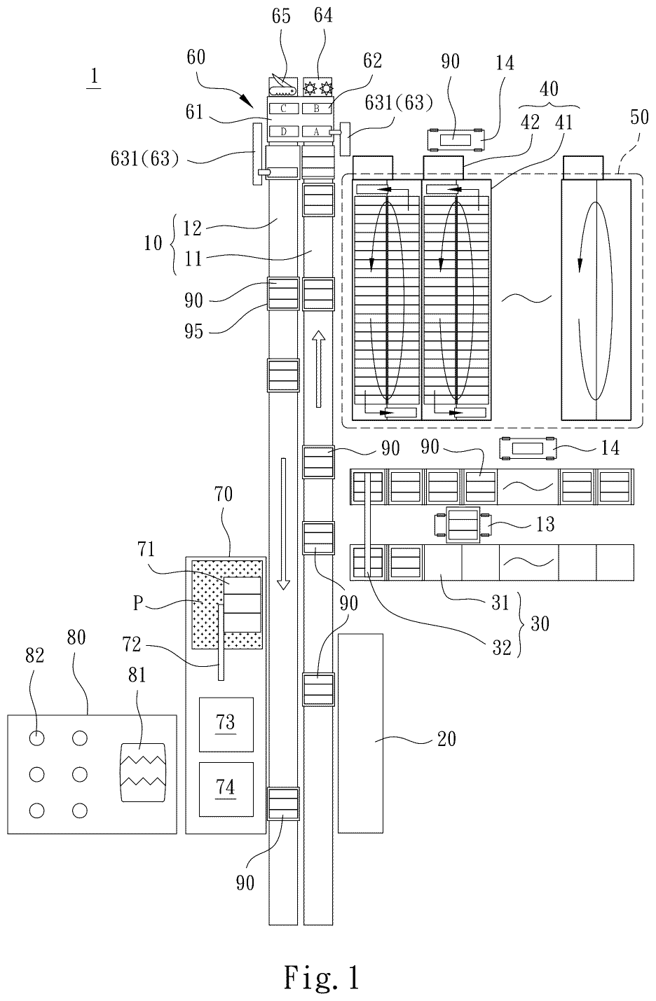

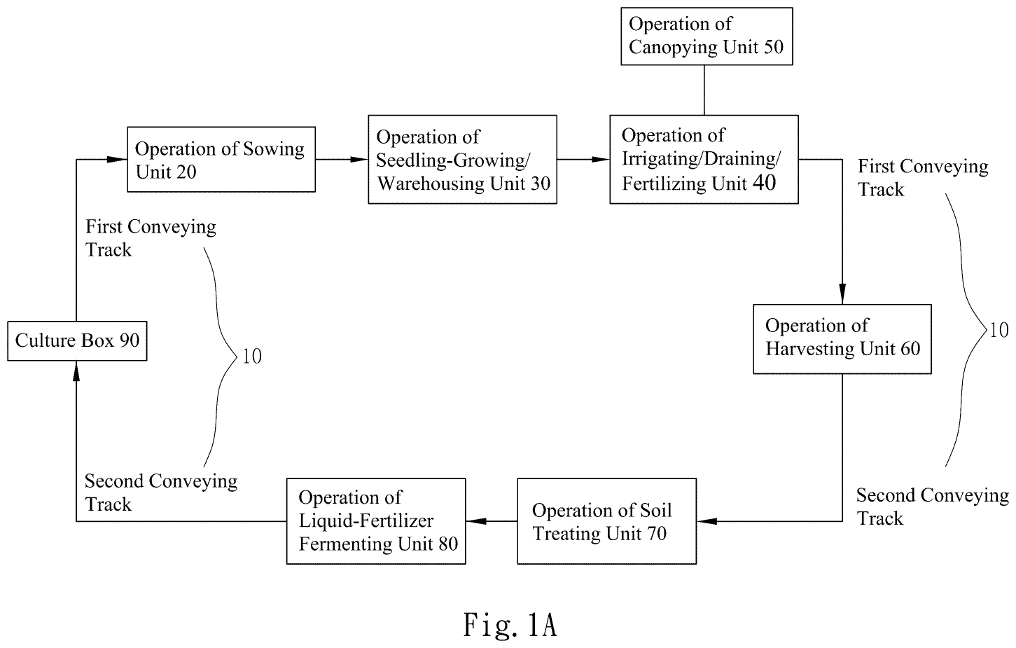

Please refer to FIG. 1 for a top view of an apparatus for systematized automated cultivation and harvesting of grain crops 1 according to one embodiment of the present invention. The apparatus 1 is to be installed in a spacious space to cultivate and harvest grain crops in unit of several culture boxes. It comprises the following units: a conveying unit (automated) 10, a sowing unit 20, a seedling-growing/warehousing unit 30, an irrigating/draining/fertilizing unit 40, a canopying unit 50, a harvesting unit 60, a soil treating unit 70, and a liquid-fertilizer fermenting unit 80. Details, functions, and structures of these units as well as relations therebetween will be detailed below.

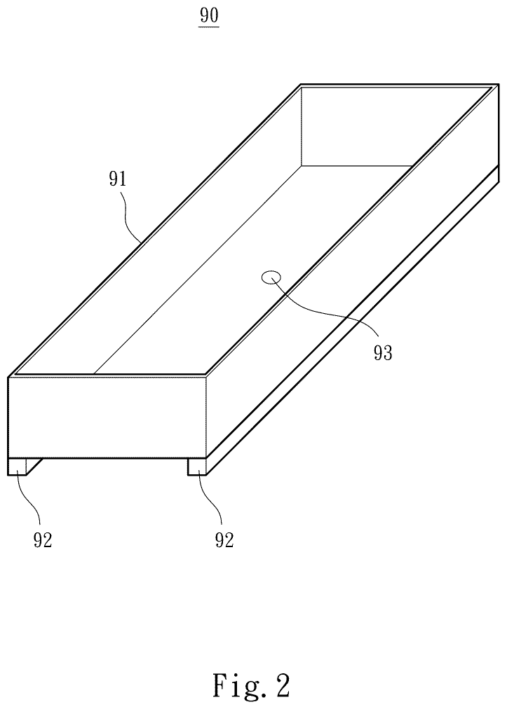

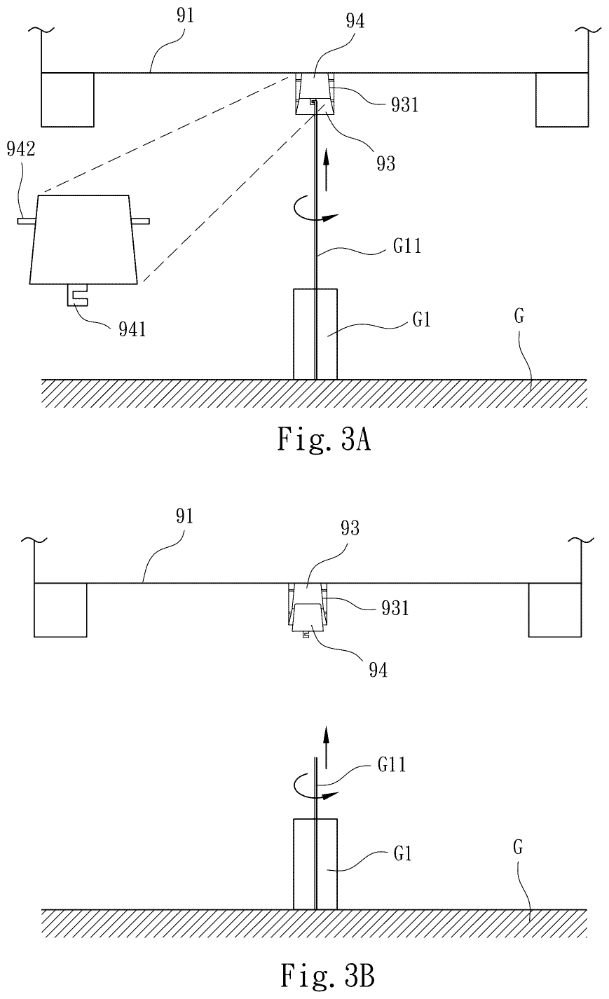

Before description of these units, culture boxed to be used in the apparatus 1 have to be introduced. FIG. 2 is a perspective view of such a culture box 90. The culture box 90 is used to cultivate grain crops (such as rice, including paddy rice and upland rice, in which the former one is described in the present embodiment for example) through various growing stages, from seed, germination, development, ripeness to harvest. Depending on the specific needs of the current stage, a culture box 90 may be transferred to different units so as to provide the optimal environment for development of rice. The culture box 90 is in the form of a rectangular open-top container 91. In the present embodiment, such a container 91 is 3-m long, 1-m wide, and 0.5-m high, but its size is not limited thereto. The container 91 has a bottom whose two sides are each provided with an underlaying square tube 92 so that the two underlaying square tubes 92 are parallel to each other and extend along the length direction of the container 91. The container 91 is formed with a drain hole 93 located between the two underlaying square tubes 92 for drainage. FIG.3A and FIG. 3B illustrate how the drain hole 93 of the container 91 works by showing different states below the container 91. A fixing ring 931 extends downward from and integrated with the periphery of the drain hole 93. The drain hole 93 is removably plugged by a drain stopper 94 at the bottom of the culture box 90 so that the fixing ring 931 and the stopper 94 jointly seal the drain hole 93. Referring to FIG. 3A, a zoom-in view of the drain stopper 94 is provided at the left. As shown, the drain stopper 94 is at its bottom provided with a hook 941. On the ground G, corresponding to a proper location, such as where the irrigating/draining/fertilizing unit 40 is installed, a drainage controller G1 is provided. The drainage controller G1 has a liftable crook G11. When the crook G11 is lifted by the drainage controller G1, it can engage with the hook 941 to push the drain stopper 94 into the drain hole 93 so that the drain hole 93 is stopped by the drain stopper 94. On the contrary, the crook G11 may go down from its lifted position in FIG. 3A and get disengaged from the hook 941. At this time, the drain stopper 94 is hung on the fixing ring 931 by its two lugs 942 (as shown in FIG. 3B), but is separated from the drain hole 93, so that water in the container 91 can drain downward on gravity. The container 91 may be made of a plastic material, such as polypropylene, or may be made of a metal material, such as an aluminum alloy.

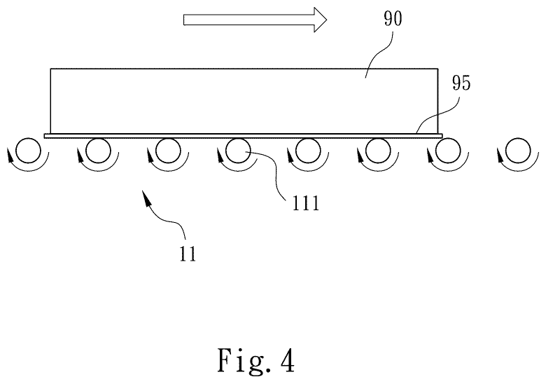

Referring back to FIG. 1 and FIG. 1A, operation of the conveying unit (automated) 10 involves using two conveying tracks, which are herein a first conveying track 11 and a second conveying track 12, to cyclically move culture boxes 90. In addition, operation of the conveying unit (automated) 10 involves using a plurality of wagons (automated) to transfer the culture boxes 90. In the present embodiment, operation of the conveying unit (automated) 10 involves using a lifting-type wagon (automated) 13 and a traversing-type wagon (automated) 14 to move the culture boxes 90 to locations outside the conveying tracks. According to the present invention, three culture boxes 90 form a set that is square when being seen from below. The set can be fit on a square base plate to move along the conveying tracks. The first conveying track 11 and the second conveying track 12 are similar in configuration. The configuration is shown in FIG. 4 with the first conveying track 11 depicted for example. The first conveying track 11 comprises several column-like roller 111 parallel to each other. The column-like rollers 111 when rolling (for example, in the clockwise direction as shown in FIG. 4) drives the square base plate 95 and the culture boxes 90 thereon to move (rightward). For transfer, the culture boxes 90 may be moved between the conveying tracks and the wagons (automated) by a mobile crane (not shown). It is to be noted that, depending on practical needs, the first conveying track 11 and the second conveying track 12 may move multiple square base plates 95 loaded with culture boxes 90 at the same time. Meanwhile, the first conveying track 11 and the second conveying track 12 may move intermittently, if not continuously.

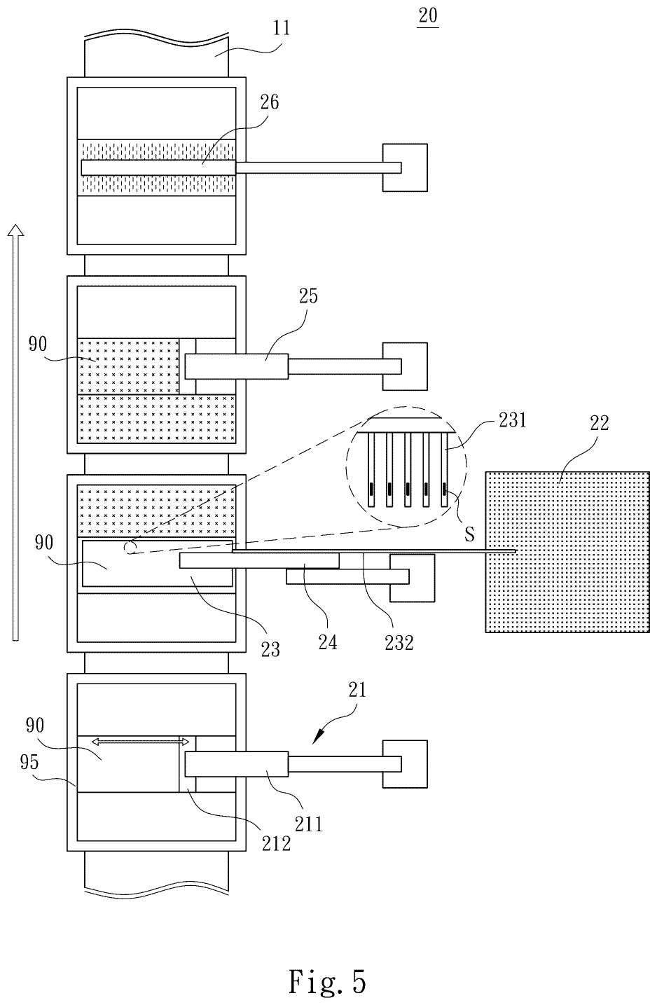

Please also refer to FIG. 5 for the detailed structure of the sowing unit 20. Generally speaking, operation of the sowing unit 20 is about sowing the culture boxes 90 that have been fertilized and have not sowed, which represent an initial state, and are fed into the first conveying track 11 from the input end, with seeds of grain crops (i.e. rice), so as to enter the culture box 90 into a prepared state. At this time, the container 91 has been filled with culture soil. The sowing unit 20 comprises a leveler 21, a grain depot 22, a broadcaster 23, a second robotic arm 24, a coverer 25, and a waterer 26. The leveler 21 uses a first robotic arm 211 to control a leveling board 212 to traverse across the fertilized and not sowed soil in the initial-state culture boxes 90 on the first conveying track 11 to and fro (as indicated by double arrow in the drawing), so as to level the soil. The grain depot 22 is a large case to be loaded with grain seed. The broadcaster 23 is arranged downstream the leveler 21 in the advancing direction of the first conveying track 11 (as indicated by the thick, hollow arrow in FIG. 5). The broadcaster 23 has a plurality of low-pressure suction tubes arranged into an array. An enlarged cross-sectional view of the broadcaster 23 is provided at the middle part of FIG. 5. In the broadcaster 23, each of the low-pressure suction tubes 231 draws a seed S with a sucking force generated by a negative pressure, and ejects the seed S when the negative pressure is replaced by a positive pressure. In the present embodiment, the low-pressure suction tube 231 has an inner diameter of about 3 mm. On the broadcasting surface of the broadcaster 23, the low-pressure suction tubes 231 form six columns, each including twenty arrays. The second robotic arm 24 is connected to the broadcaster 23, and when moving, it controls the broadcaster 23 to move between the grain depot 22 and the culture boxes 90, so that the broadcaster 23 places the grain seeds to predetermined locations in the culture boxes 90. In the drawing, the culture boxes 90 that have been sowed are marked with round dots that represent the grain seeds S. Meanwhile, a suction tube 232 is mounted on the second robotic arm 24 and connected to the broadcaster 23. The broadcaster 23 picks up grain seeds S from the grain depot 22 by suction and distributes them to the low-pressure suction tubes 231. The coverer 25 is arranged downstream the first conveying track 11 in the moving direction of the broadcaster 23, and cover the seeds sowed in the culture boxes 90 with soil. The waterer 26 is arranged downstream the coverer 25 in the advancing direction of the first conveying track 11 and waters the culture boxes 90 to keep the soil humid, thereby facilitating germination of the grain seeds S.

The culture boxes 90 in the prepared state where they have been sowed with the grain seeds S and watered are then moved along the first conveying track 11 to enter the seedling-growing/warehousing unit 30 for operation of growing seedlings. After the operation of growing seedlings, with presence of the grown seedlings, the culture boxes 90 come into their seedling state. Operation of the seedling-growing/warehousing unit 30 involves use of a storage rack 31 that defines therein a plurality of storage spaces. The lifting-type wagon (automated) 13 moves the sowed culture boxed 90 in the prepared state from the first conveying track 11 to the designated storage spaces for storage, and moves the culture boxes 90 that have passed the seedling-growing period (e.g., two months for germination and seedling growth to complete) and are now in the seedling state back to the first conveying track 11. The seedling-growing/warehousing unit 30 further comprises a sprayer 32. The sprayer 32 may stretch into each of the storage spaces to water the culture boxes 90 stored in the storage spaces, thereby satisfying a minimum water requirement that supports growth of seedlings of the grain crops. In the present embodiment, the seedling-growing/warehousing unit 30 comprises two storage racks 31. Each of the storage racks 31 has twenty layers and each layer has twenty partitions. Each partition is designed to receive a square base plate 95 loaded with three culture boxes 90. In practical use, the storage rack 31 may have a different structure, without limitation.

The irrigating/draining/fertilizing unit 40 is to be installed in a space where sufficient sunlight is available. Its operation involves using a cyclical conveying track 41 and a watering/fertilizing device 42 to grow the grain seedlings to their ripeness. In the present embodiment, the cyclical conveying track 41 may be at least three in number. The irrigating/draining/fertilizing unit 40 uses the traversing-type wagon (automated) 14 to take the culture boxes 90 in the seedling state away from the square base plates 95 on the first conveying track 11 and move them to the cyclical conveying tracks 41. Afterward, the cyclical conveying track 41 move anti-clockwise to send the culture boxes 90 to the watering/fertilizing device 42 where they are watered and fertilized, so that the plants in the culture boxes 90 grow to their harvestable stage and enter the culture boxes 90 into their rip state. The culture boxes 90 that have passed the development stage of the plants (e.g., about two months for rice) and are now in the ripe state are sent back to the first conveying track 11 by the traversing-type wagon (automated) 14. The cyclical conveying tracks 41 are similar to the conveying tracks, each comprising several column-like rollers that are parallel to each other. The column-like rollers when rolling drive the culture boxes 90 to move. As described previously, a drainage controller G1 may be arranged among the column-like rollers and uses an extendable crook G11 that is detachably connected to a drain stopper 94 to pull out the drain stopper 94 and allow water in the culture box 90 to drain downward.

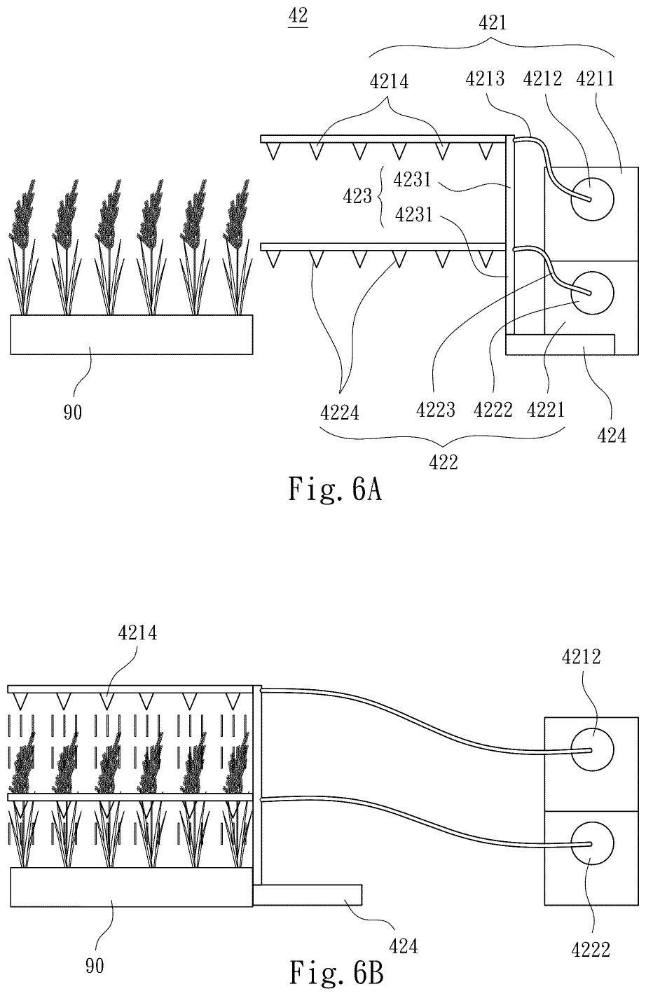

Please also refer to FIG. 6A and FIG. 6B for the detailed structure and operation of the watering/fertilizing device 42. The watering/fertilizing device 42 comprises a fertilizing module 421, a water-spraying module 422, a fixed frame 423, and a displacer 424. The fertilizing module 421 further comprises a liquid-fertilizer storage tank 4211, a first water-pumping motor 4212, a first pipe 4213, and a plurality of liquid-fertilizer nozzles 4214. The liquid-fertilizer storage tank 4211 is for storing liquid fertilizer. The first pipe 4213 and the first water-pumping motor 4212 are connected to each other. The first water-pumping motor 4212 when operating pumps the liquid fertilizer from the liquid-fertilizer storage tank 4211 to the first pipe 4213. Each of the liquid-fertilizer nozzles 4214 is connected to the first pipe 4213 and serves to spray the liquid fertilizer. The liquid fertilizer may be a leaf fertilizer. The water-spraying module 422 further comprises a clean-water tank 4221, a second water-pumping motor 4222, a second pipe 4223, and a plurality of clean-water nozzles 4224. The clean-water tank 4221 is for storing clean water. The second pipe 4223 and the second water-pumping motor 4222 are connected to each other. The second water-pumping motor 4222 when operating pumps the clean water from the clean-water tank 4221 to the second pipe 4223. Each of the clean-water nozzles 4224 is connected to the second pipe 4223 and serves to spray clean water. The fixed frame 423 has an upper shelf 4231 and a lower shelf 4232. The liquid-fertilizer nozzles 4214 are arranged along the upper shelf 4231, and the clean-water nozzles 4224 are arranged along the lower shelf 4232. The displacer 424 carries the fixed frame 423 and is located at one end of the cyclical conveying track 41. When a culture box 90 is delivered to the watering/fertilizing device 42 through the cyclical conveying track 41, the displacer 424 approaches the culture box 90, and makes the watering/fertilizing device 42 change from a position as shown in FIG. 6A to a position as shown in FIG. 6B. The first water-pumping motor 4212 operates so as to apply the liquid fertilizer to rice leaves from above through the liquid-fertilizer nozzles 4214. The second water-pumping motor 4222 operates so as to spray clean water to rice roots through the clean-water nozzles 4224. After irrigation and fertilization, the displacer 424 returns to its home position (i.e. the position as shown in FIG. 6A), leaving the culture boxes 90 keeping circulating along the cyclical conveying track 41.

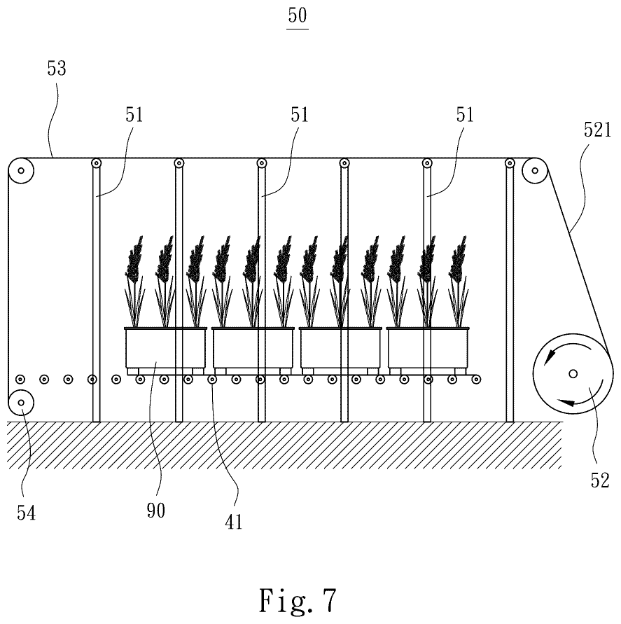

The canopying unit 50 canopies the cyclical conveying track 41 from above, and serves to unroll a rain cover in case of heavy rain so as to protect the plants from direct rain hits. The canopying unit 50 is represented by a dotted frame in FIG. 1 as it overlaps the irrigating/draining/fertilizing unit 40. FIG. 7 shows the detailed structure of the canopying unit 50. The canopying unit 50 further comprises a plurality of arch-like ribs 51, a rain-cover roll 52, a guiding steel wire 53, and a wire winch 54. The arch-like ribs 51 span over the cyclical conveying track 41. The rain-cover roll 52 contains a rain cover 521 that is rolled up. The rain cover 521 is normally rolled up and can be unrolled to slidably spread over the arch-like ribs 51 when receiving an external pulling force. When the pulling force disappears, the rain-cover roll 52 rolls the rain cover 521 back to its enclosure. The guiding steel wire 53 has its one end tied on the terminal of the rain cover 521. It is normally unwound and slidably spreads over the arch-like ribs 51. The wire winch 54 is connected to the opposite end of the guiding steel wire 53 so that when the wire winch 54 winds the guiding steel wire 53, it generates the external pulling force that pulls and unrolls the rain cover 521.

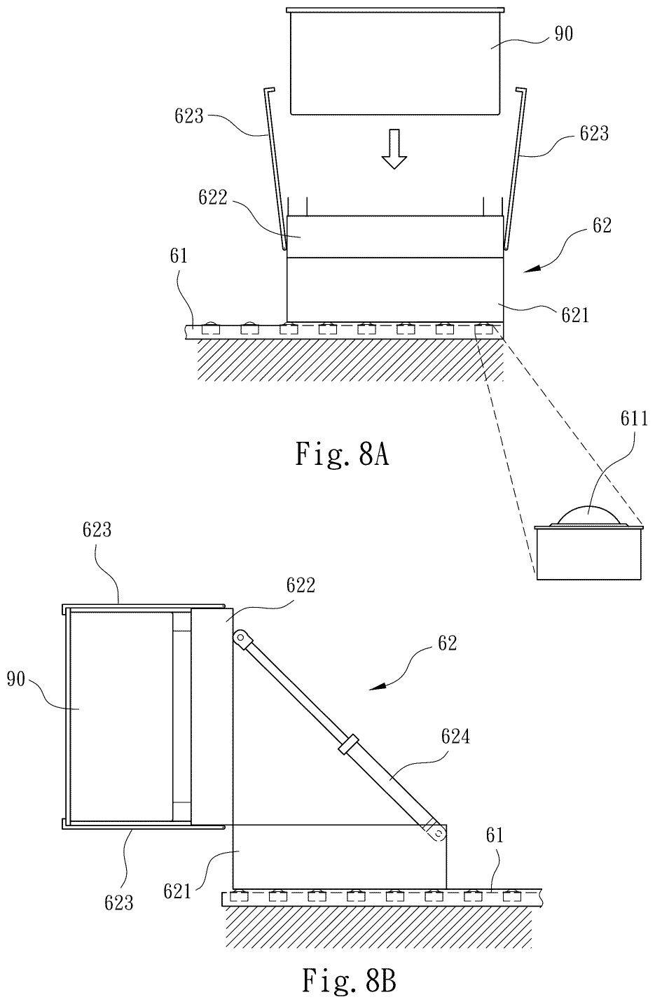

Operation of the harvesting unit 60 happens at a joint between the first conveying track 11 and the second conveying track 12. Particularly, the operation is about tilting the culture boxes 90 that contain the harvestable plants and are in the ripe state to one side against the first conveying track 11, removing grains from stems, cutting stems and leaves of the plants, and placing the culture boxes 90 so processed onto the second conveying track 12 to allow then to be moved toward the input end of the first conveying track 11. To this end, the harvesting unit 60 further comprises a workbench 61, a plurality of culture box manipulators 62, a machine-controlled arm complex 63, at least one threshing device 64, and a cutter 65. FIG. 8A and FIG. 8B illustrate the workbench 61 and the culture box manipulator 62 in detail. The workbench 61 is provided with a plurality of rolling shafts 611 so that the culture boxes 90 in the ripe state can be slid thereon (by the culture box manipulators 62). In the present embodiment, there are four culture box manipulators 62 used. The culture box manipulators 62 cyclically operate on the workbench 61. Each of the culture box manipulators 62 further comprises a bottom shell 621, a top plate 622, a pair of claiming jaws 623, and an air cylinder 624. The top plate 622 and the bottom shell 621 have the same projection area in the top-view plane, which is slightly larger than that of the culture boxes 90. The top plate 622 has an upper plane that is configured to carry a culture box 90. The top plate 622 may have its left lateral hinged to a lateral of the bottom shell 621. The two claiming jaws 623 are installed at the left and right laterals of the top plate 622, respectively, so that they can operatably close to hold the culture box 90 therebetween, as shown in FIG. 8A. The air cylinder 624 has two ends thereof hinged to the right lateral of the top plate 622 and the opposite lateral of the bottom shell 621. The air cylinder 624 when operating makes the top plate 622 and the bottom shell 621 rotate with respect to each other against where they are hinged. The machine-controlled arm complex 63 comprises a plurality of machine-controlled arms 631. In the present embodiment, two machine-controlled arms 631 are used for example. The machine-controlled arms 631 are for moving the culture boxes 90 in the ripe state from the first conveying track 11 to corresponding culture box manipulators 62 on the workbench 61, moving the culture box manipulators 62 to predetermined locations on the workbench 61, and moving the culture boxes 90 that have undergone harvest and are in the harvested state from the culture box manipulators 62 to the second conveying track 12. In the present embodiment, at least one threshing device 64 is used and installed at one side of the workbench 61. When operating, the threshing device 64 removes grains from the plants in the tilted culture box 90 in the ripe state by threshing. The cutter 65 is located at the same side on the workbench 61 as the threshing device 64, and serves to cut stems and leaves of the plants after the foregoing threshing process.

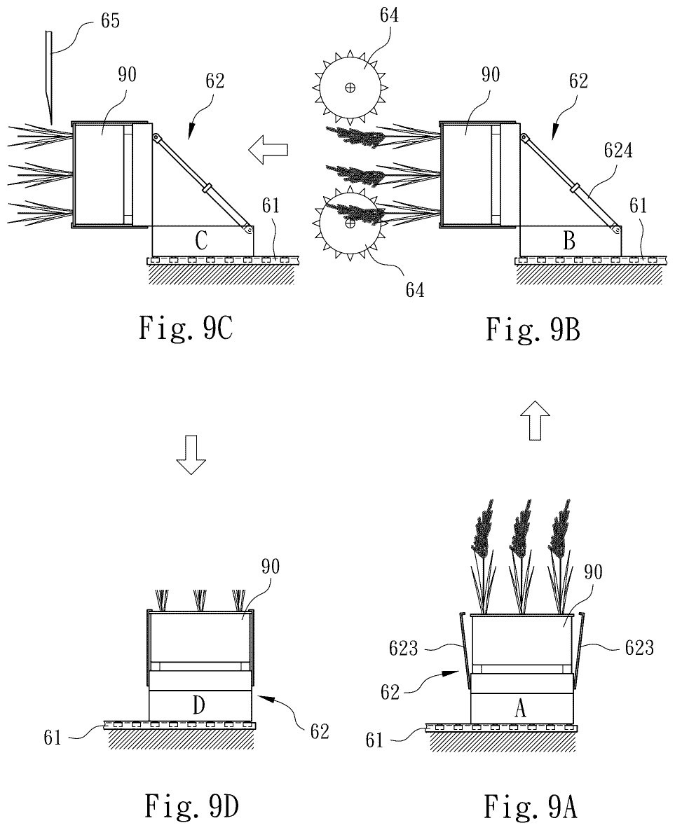

For better illustrating the operation of the harvesting unit 60, FIG. 1 and FIGS. 9A through 9D provide different operational aspects of a culture box manipulator 62 at different locations. In FIG. 1, the culture box manipulator 62 are at four locations, namely A, B, C, and D, on the workbench 61, successively. In FIG. 9A through FIG. 9D, the operational aspects of the culture box manipulator 62 are depicted. The culture box manipulator 62 at Location A has its claiming jaws 623 open to clamp the culture box 90. The plants in the culture boxes 90 are now harvestable. The culture box 90 then moves to Location B. When the claiming jaws 623 hold the culture box 90, the air cylinder 624 stretch to make the top plate 622 rotate with respect to the bottom shell 621 for about 90 degrees so as to tilt the culture box. At this time, the threshing device 64 operates to remove grains from the plants in the culture box 90. Afterward, the culture box manipulator 62 on the workbench 61 is moved by the machine-controlled arm 631 to Location C where it is in front of the cutter 65. The cutter 65 cuts stems and leaves of the thrashed plants. At last, the culture box manipulator 62 moves to Location D. After the plants in the culture box 90 have been cut off, the air cylinder 624 retracts so as to rotate the top plate 622 and lay it on the bottom shell 621. The claiming jaws 623 release the culture box 90. Then the machine-controlled arms 631 move the post-harvest culture boxes 90 from the culture box manipulators 62 to the second conveying track 12. At this time, the culture boxes 90 are on the harvested state.

The culture box 90 that has been processed by the harvesting unit 60 and are in the harvested state now contains only soil, stem remains, and plant roots. Such a culture box 90 has to be renewed before being fed into the cyclical cultivation operation. The soil treating unit 70 is provided for preparing the culture boxes 90 for the subsequent cyclical cultivation operation. Particularly, operation of the soil treating unit 70 is about ripping the soil, removing roots and weeds from the soil, sterilizing and fertilizing the soil in the culture boxes 90 coming from the second conveying track 12, and moving the culture boxes 90 so processed to the first conveying track 11 as renewed culture boxes 90 that are ready to be cyclically fed into the conveying unit (automated) 10. The soil treating unit 70 comprises a plurality of soil-ripping/root-removing devices 71, a third robotic arm 72, a steam-based sterilizing/weeding device 73, and a liquid-fertilizer applicator 74, which will be described in detail below.

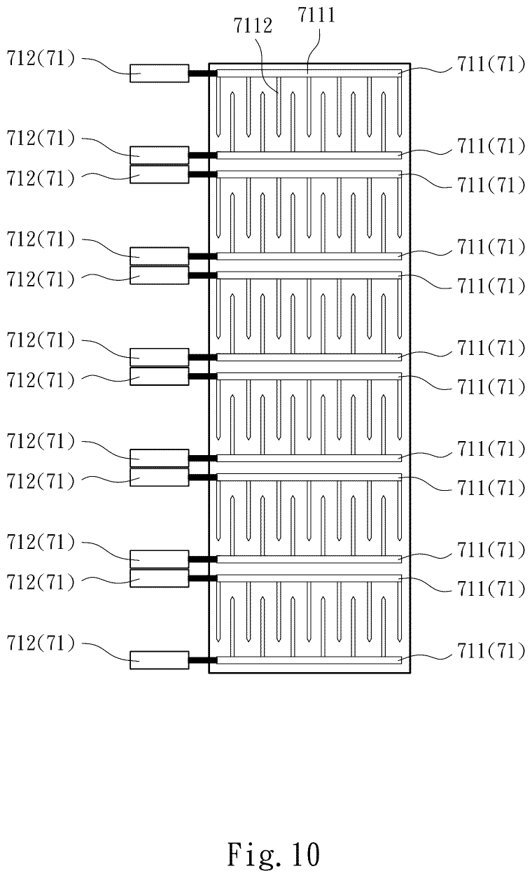

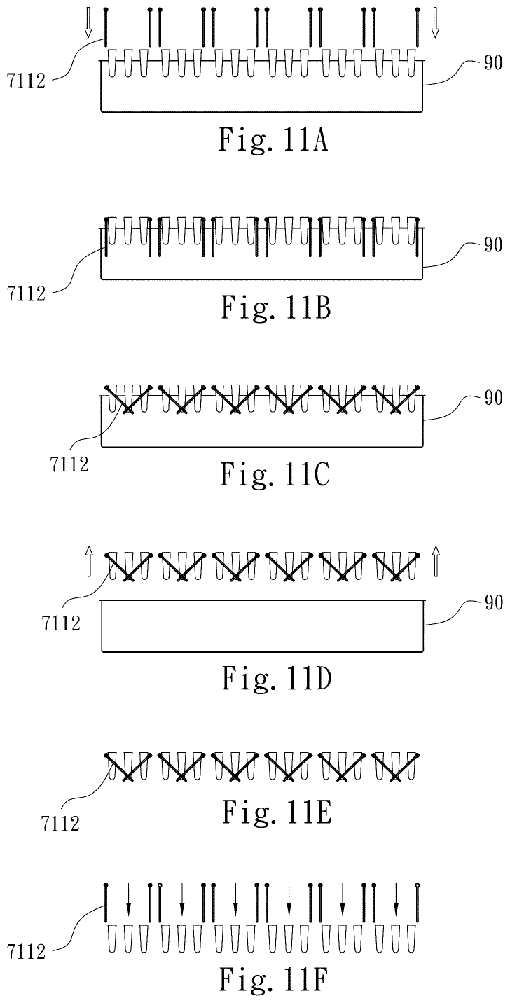

Referring to FIG. 10, a top view of six soil-ripping/root-removing devices 71is shown. Each of the soil-ripping/root-removing devices 71 comprises at least two rotary rakes 711 and at least two controlling motors 712. Each of the rotary rakes 711 is constructed from a rotating shaft 7111 and plural spikes 7112 perpendicularly combined to the rotating shaft 7111. The controlling motors 712 are connected to the respective rotating shafts 7111 of the rotary rakes 711 so as to make the rotating shafts 7111 rotate oppositely and synchronously. By doing so, the two rotary rakes 711 are posed in a contracted state where their spikes 7112 are opposite and parallel to each other; in an expanded state where their spikes 7112 are parallel to each other and all pointed downward; or a root-removing state where their spikes 7112 are staggered. Referring to FIG. 11A through FIG. 11F, several operational aspects of the third robotic arm 72 and the soil-ripping/root-removing devices 71 are depicted. The third robotic arm 72 is connected to the soil-ripping/root-removing devices 71 for controlling the soil-ripping/root-removing devices 71 to perform the following operations. Referring to FIG. 11A, in the first operation, the third robotic arm 72 moves a soil-ripping/root-removing devices 71 from a root-removing area P to a location over the culture boxes 90 that have undergone the cutting operation, and poses the soil-ripping/root-removing devices 71 into their expanded state where the spikes 7112 point downward. At this time, the spikes 7112 have their terminals pointed to the surface of the soil in the culture boxes 90. In the second operation, as illustrated by FIG. 11B, the third robotic arm press the soil-ripping/root-removing devices 71 downward so that the spikes 7112 thrust into the soil in the culture boxes 90. In the third operation, corresponding to FIG. 11C, the third robotic arm 72 poses the soil-ripping/root-removing devices 71 into its root-removing state where the spikes 7112 are staggered. Particularly, two adjacent rotating shafts 7111 form a 45-degree angular offset, so that the staggered spikes 7112 can grasp plant remains in the soil and some collateral soil. In the fourth operation, referring to FIG. 11D, the third robotic arm 72 pulls the soil-ripping/root-removing devices 71 up. At this time, the spikes 7112 staggered between the two rotary rakes 711 hold the plant remains and pull them out of the culture boxes 90. Then, in the fifth operation, as shown in FIG. 11E, the third robotic arm 72 moves the soil-ripping/root-removing devices 71 back to the root-removing area P. At last, referring to FIG. 11F, in the sixth operation, the third robotic arm 72 returns the soil-ripping/root-removing devices 71 into their expanded state where the spikes 7112 point downward, thereby allowing the plant remains to fall in the root-removing area P and completing a session of the root-removing operation.

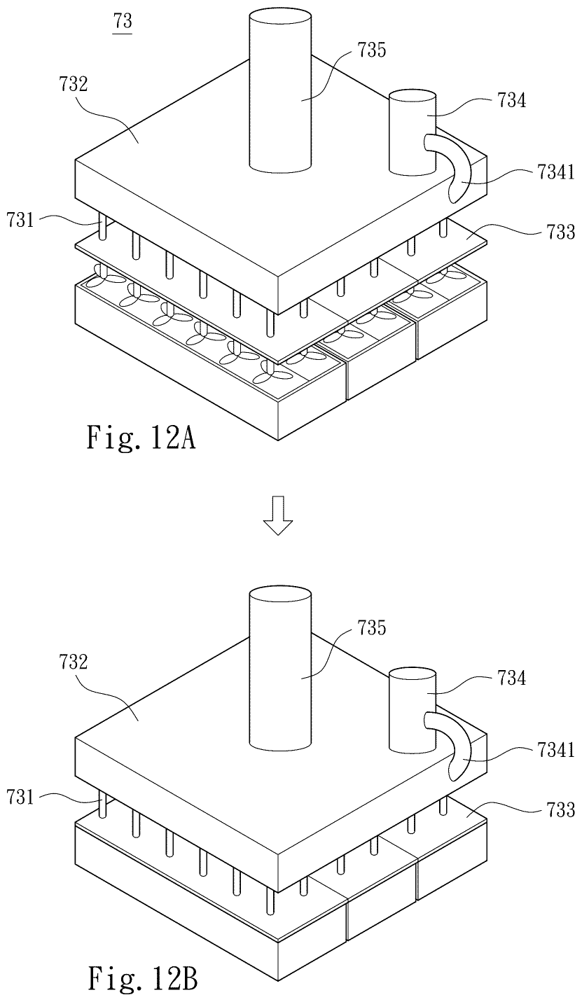

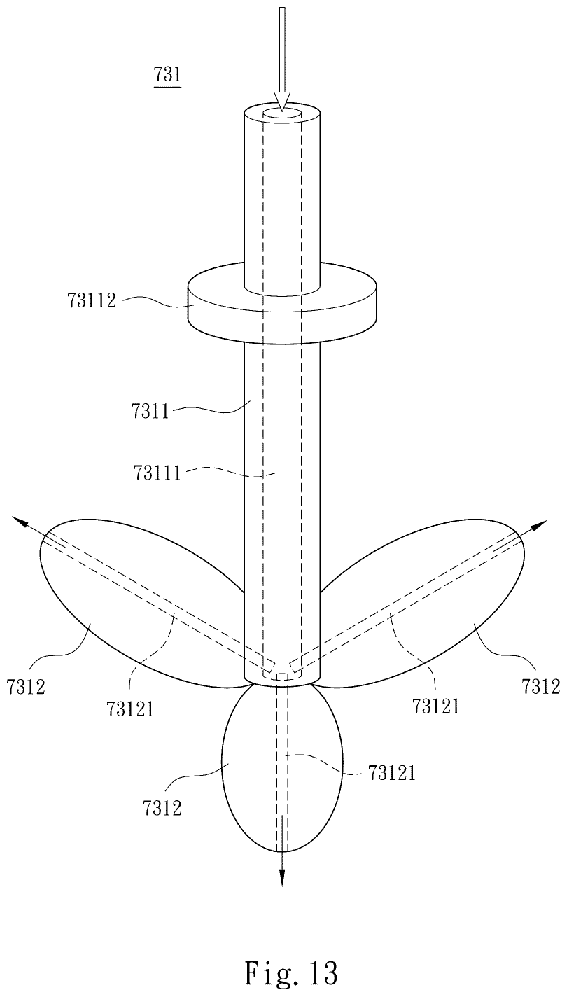

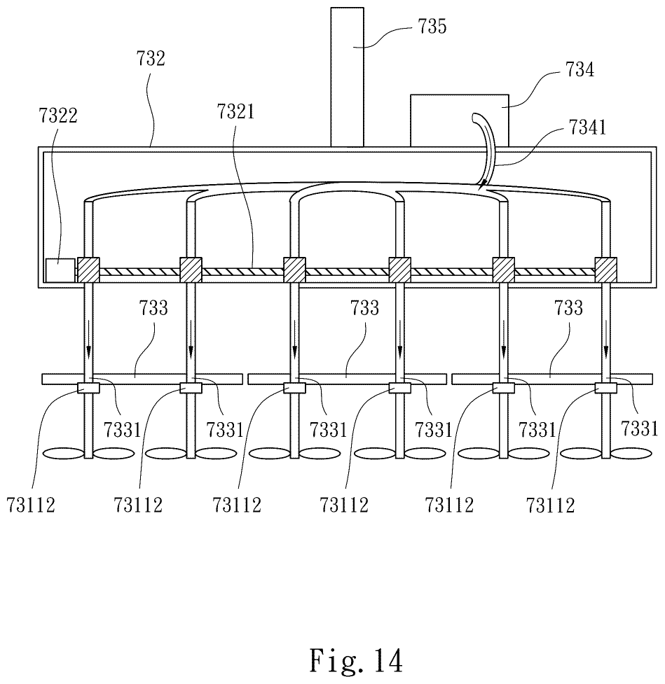

After the plant roots and remains are removed, the soil in the culture boxes 90 needs to be improved by killing bacteria that may harm subsequent cultivation. The steam-based sterilizing/weeding device 73 is designed for this purpose. Referring to FIG. 12A and FIG. 12B, the applied views of the steam-based sterilizing/weeding device 73 are provided. The steam-based sterilizing/weeding device 73 is hung over the second conveying track 12 by means of a bracket or a ceiling board. It comprises a plurality of steaming stirring rods 731, a first transmission box 732, three fixing plates 733, a steam generator 734, and a first lifting device 735. The structure of the steaming stirring rod 731 is shown in FIG. 13, with the internal arrangements are depicted using dotted lines. The steaming stirring rod 731 comprises a first tube 7311 and a plurality of steaming/stirring blades 7312 fixedly connected to one end of the first tube 7311. Each of the first tubes 7311 defines therein a channel 73111 and is peripherally provided with a support ring 73112 at its middle part. Each of the steaming/stirring blades 7312 defines therein an air-guiding pipe 73121, which is communicated with the channel 73111 in the first tube 7311. When the channel 73111 in the first tube 7311 is filled with steam (as indicated by the thick arrow), the steam flows out through the air-guiding pipe 73121 (as indicated by the thin arrow). In the present embodiment, there are thirty-six steaming stirring rods 731 arranged into a 6×6 array. Every twelve steaming stirring rods 731 manage sterilization for a culture box 90. The first transmission box 732 encloses the other end of each of the first tubes 7311. Referring to FIG. 14, in the cross-sectional view of the first transmission box 732, the internal structure is depicted. The first transmission box 732 contains a first transmission mechanism 7321 and a drive motor 7322. The drive motor 7322 drives the first transmission mechanism 7321 to operate to rotate the steaming stirring rods 731 synchronously. More specifically, the first transmission mechanism 7321 may be a plurality of power screws connected to the drive motor 7322. Each of the power screws can rotate six externally threaded rods that are fixedly connected to the steaming stirring rod 731. In practical use, depending on desired performance of rotation, the first transmission mechanism 7321 and the drive motor 7322 may each be plural in number. For example, nine drive motors 7322 may be used and each drive motor 7322 drives four connected steaming stirring rods 731 through a first transmission mechanism. Each of the fixing plates 733 has a profile matching the top opening of the corresponding culture box 90 and is provided with round holes. In each round hole 7331 a first tube 7311 is inserted. Thereby, each fixing plate is supported by the supporting rings 73112. The steam generator 734 is mounted on the first transmission box 732, and is connected to the first tubes 7311 through a connecting pipe 7341. It generates steam (as indicated by the arrow in FIG. 14) and sends the steam to the first tubes 7311. The first lifting device 735 is connected between the first transmission box 732 and the bracket or the ceiling board, and is used to adjust the altitude of the first transmission box 732. As to the operation of the steam-based sterilizing/weeding device 73, when three culture boxes 90 are moved by the second conveying track 12 to a place below the steam-based sterilizing/weeding device 73, the first lifting device 735 lowers the first transmission box 732 in altitude so that the steaming/stirring blades 7312 of the steaming stirring rods 731 insert into the soil, making the steam-based sterilizing/weeding device 73 change from the state as shown in FIG. 12A to the state as shown in FIG. 12B. Each of the fixing plates 733 covers the opening of the corresponding culture box 90. The steam generator 734 and the at least one drive motor 7322 then start to operate. The steaming stirring rods 731 rotate and the steam flowing out of the air-guiding pipe 73121 kills bacteria and weeds in the soil to accomplish the sterilization and weeding operation. Upon completion of the sterilization and weeding operation, the steam generator 734 and the at least one drive motor 7322 stop. Then the first lifting device 735 lifts the first transmission box 732 in altitude so as to make the steaming/stirring blades 7312 of the steaming stirring rods 731 leave the soil. This makes the steam-based sterilizing/weeding device 73 change from the state as shown in FIG. 12B back to the state as shown in FIG. 12A, so that the culture boxes 90 can resume advancing as the second conveying track 12 is activated.

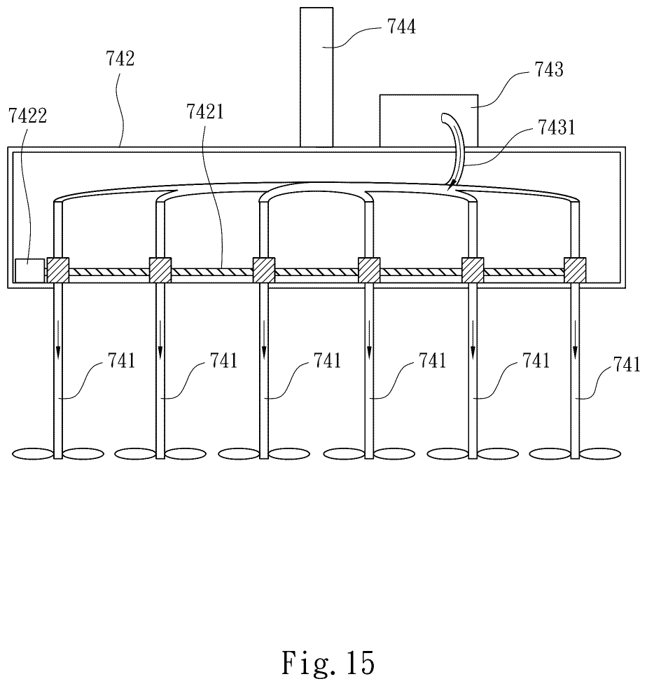

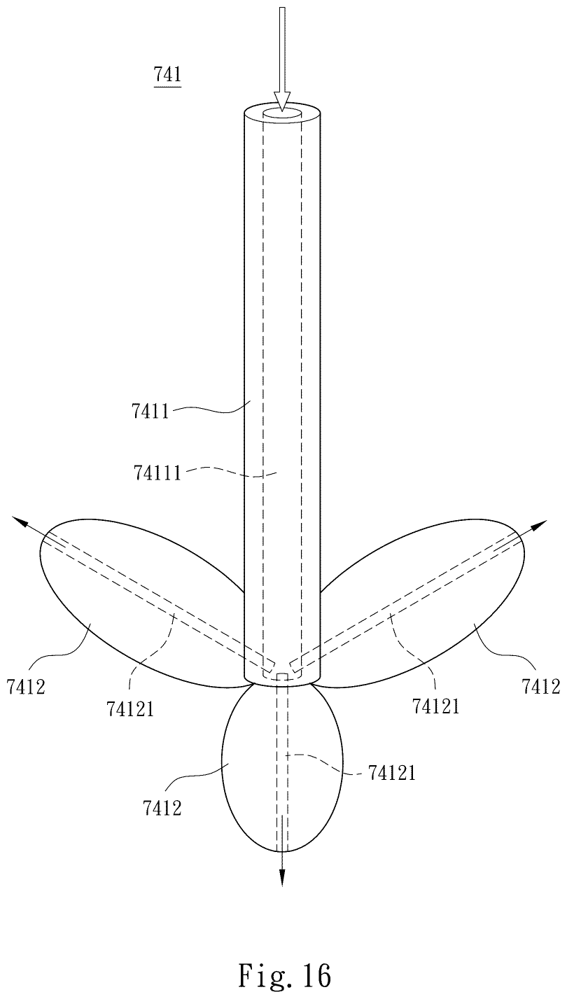

The soil in the culture box 90 having undergone sterilization is preferably fertilized with liquid fertilizer. The liquid-fertilizer applicator 74 is designed for this purpose. For bettering detailing the liquid-fertilizer applicator 74, FIG. 15 provides a cross-sectional view of it. The liquid-fertilizer applicator 74 is hung over the second conveying track 12 by means of a bracket or a ceiling board. It comprises a plurality of fertilizer dispensing rods 741, a second transmission box 742, a fertilizer dispenser 743, and a second lifting device 744. FIG. 16 illustrates the external structure of the fertilizer dispensing rods 741. Each of the fertilizer dispensing rods 741 comprises a second tube 7411 and a plurality of liquid-fertilizer stirring blades 7412 fixedly connected to one end of the second tubes 7411. Each of the second tubes 7411 defines therein a channel 74111. Each of the liquid-fertilizer stirring blades 7412 defines therein a liquid-guiding pipe 74121. The liquid-guiding pipe 74121 is communicated with the channels 74111 in the second tube 7411. When the channels 74111 in the second tubes 7411 are filled with the liquid fertilizer (indicated by the thick arrow), the liquid fertilizer comes out form the liquid-guiding pipe 74121 (as indicated by the thin arrow). The second transmission box 742 encloses the other end of each of the second tubes 7411. Similarly, the second transmission box 742 contains therein a second transmission mechanism 7421 and at least one drive motor 7422. The at least one drive motor 7422 drives the second transmission mechanism 7421 to operate to rotate the fertilizer dispensing rods 741 synchronously. The fertilizer dispenser 743 is mounted on the second transmission box 742, and is connected to the second tubes 7411 through the connecting pipe 7431 for supplying the liquid fertilizer (as indicated by the arrow in FIG. 14) to the second tubes 7411. The second lifting device 744 is connected between the second transmission box 742 and the bracket or the ceiling board, and is used to adjust the altitude of the altitude of the second transmission box 742. As to the operation of the liquid-fertilizer applicator 74, when the three culture boxes 90 are moved by the second conveying track 12 to a place below the liquid-fertilizer applicator 74, the second lifting device 744 lowers the second transmission box 742 in altitude so that the liquid-fertilizer stirring blades 7412 of the fertilizer dispensing rods 741 insert into the soil. The fertilizer dispenser 743 and the at least one drive motor 7422 start to operate. The fertilizer dispensing rods 741 rotate and the liquid fertilizer flowing out of the liquid-guiding pipes 74121 fertilizes the soil. Upon completion of the fertilization operation, the fertilizer dispenser 743 and the at least one drive motor 7422 stop. Then the second lifting device 744 lifts the second transmission box 742 in altitude so as to make the liquid-fertilizer stirring blades 7412 of the fertilizer dispensing rods 741 leave the soil. Then the culture boxes 90 now can resume advancing as the second conveying track 12 is activated, and are renewed into culture box 90 in the initial state. The initial-state culture boxes 90 renewed and fertilized are sent to the terminal of the second conveying track 12 and transferred to the first conveying track 11 where they are put into the operation of the sowing unit 20 again.

The present invention may further include production of the liquid fertilizer in addition to simply supplying ready-made liquid fertilizer to soil in the culture boxes 90. A liquid-fertilizer fermenting unit 80 shatters plant stems and leaves cut by the harvesting unit 60 and plant roots and other remains extracted from the soil by the soil treating unit 70, and makes the shattered fine pieces ferment so as to produce the liquid fertilizer for the soil treating unit 70 and the irrigating/draining/fertilizing unit 40 to use. The liquid-fertilizer fermenting unit 80 comprises a shredder 81 and a plurality of liquid-fertilizer fermenting tanks 82. The shredder 81 shatters the plant stems and leaves cut by the harvesting unit 60 and plant roots and weeds extracted from the soil by the soil treating unit 70 into fine pieces. Each of the liquid-fertilizer fermenting tanks 82 stores the fine pieces and ferments the fine pieces so as to produce the liquid fertilizer. The liquid fertilizer is then delivered to the fertilizer dispenser 743 or the liquid-fertilizer storage tank 4211 through a connecting pipe. In the present embodiment, the six liquid-fertilizer fermenting tanks 82 may each be a 2*6 m vertical column.

Briefly, the present invention divides the entire growth period of grain crops, i.e., from seedling growing and development to ripeness, into two parts. In other words, the working domain of the seedling-growing/warehousing unit 30 and the irrigating/draining/fertilizing unit 40 are separated from working domain of the other units whose operations are not related to growth of the plants. This allows operations corresponding to cultivation of the grain crops, including seedling growing, development, and ripeness, and other operations not related to cultivation of the grain crops to be conducted synchronously in different working domains. Thereby, every kind of grain crops are allowed to make full use per unit time for continuous, cyclical operations of seedling growing, development, and ripeness of the grain crops, so as to significantly increase the number of harvests per unit time and increase the overall yield, thus achieving the primary objective of the present invention.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for systematized cultivation of grain crops, which involves performing cultivation and harvest of the grain crops on plural culture boxes as a set, and comprises:
operation of a conveying unit, which involves using two conveying tracks, which include a first conveying track and a second conveying track, to cyclically convey the culture boxes and using a plurality of wagons to transfer the culture boxes and accomplish a box-transferring activity;
operation of a sowing unit, which involves feeding the culture boxes that are in an initial state to the apparatus at an input end of the first conveying track, wherein the culture boxes each contain culture soil that has been fertilized but has not been sowed, and sowing the culture soil in the culture boxes with seeds of the grain crops so as to enter the culture boxes into a prepared state;
operation of a seedling-growing/warehousing unit, which involves providing a storage rack that defines therein a plurality of storage spaces, using a lifting-type wagon to move the culture boxes that are in the prepared state and on the first conveying track to the storage spaces, respectively, for storage and cultivation thereby accomplishing germination and seedling-growing of the grain crops, so as to enter the culture boxes into a seedling state, and using the lifting-type wagon to send the culture boxes that have stored in the storage spaces for a seedling-growing period and are in the seedling state back to the first conveying track, thereby accomplishing a seedling-growing activity; and
operation of an irrigating/draining/fertilizing unit, which involves providing a cyclical conveying track in a space where sunlight sufficient to growth of the grain crops is available, using a traversing-type wagon to send the culture boxes in the seedling state from the first conveying track to the cyclical conveying track for cyclical conveyance, using a watering/fertilizing device for watering and fertilization so as to support the grain crops during a growth period of the grain crops so as to accomplish a crop-growing activity and enter the culture boxes in a ripe state upon expiration of the growth period; and using the traversing-type wagon to send the culture boxes that are in the ripe state and have been cyclically conveyed on the cyclical conveying track back to the first conveying track, so as to cultivate the grain crops in the culture boxes into a harvestable state, thereby accomplishing a complete crop-cultivating activity of the grain crops.

2. The method of claim 1, further comprising operation of a canopying unit, which involves using a rain cover that spreads over the cyclical conveying track to protect the grain crops from a direct rain hit during heavy rain.

3. The method of claim 1, further comprising operation of a harvesting unit, wherein the harvesting unit is located at a joint between the first conveying track and a second conveying track downstream the irrigating/draining/fertilizing unit, and the operation involves tilting the culture boxes in the ripe state against the first conveying track to a side, removing grains from stems of the ripe grain crops so as to accomplish a grain-harvesting activity, placing the culture boxes now in a harvested state onto the second conveying track, and moving the culture boxes toward the input end of the first conveying track so as to allow cyclical implementation of a method for cultivation and harvest of the grain crops.

4. The method of claim 3, further comprising operation of a soil treating unit, wherein the soil treating unit is located downward the harvesting unit, and the operation involves ripping the culture soil, removing roots of the grain crops and weeds from the culture soil, sterilizing and fertilizing the culture soil in the culture boxes that are in the harvested state and come from the second conveying track, so as to renew the culture boxes into the initial state, and transferring the culture boxes in the initial state to the input end of the first conveying track.

5. The method of claim 4, further comprising operation of a liquid-fertilizer fermenting unit, which involves shattering stems and leaves cut off from the grain crops by the harvesting unit and the roots of the grain crops and weeds removed by the soil treating unit operation into fine pieces, fermenting the fine pieces to produce a liquid fertilizer, and providing the liquid fertilizer for the soil treating unit operation and the irrigating/draining/fertilizing unit operation to use.

6. An apparatus for systematized cultivation of grain crops, comprising:
a conveying unit, which comprises two conveying tracks that include a first conveying track and a second conveying track, wherein the two conveying tracks cyclically convey a plurality of culture boxes for containing culture soil and cultivating the grain crops; and further comprises wagons for moving the culture boxes;
a sowing unit, which comprises a broadcaster for sowing seeds of the grain crops to the fertilized and unsowed culture soil in the culture boxes fed at an input end of the first conveying track;
a seedling-growing/warehousing unit, which is arranged downstream the sowing unit and comprises a storage rack that defines therein a plurality of storage spaces, wherein a wagon moves the culture boxes that are on the first conveying track and have the culture sowed with the seeds of the grain crops to the storage spaces, respectively, for storage and cultivation, and the wagon sends the culture boxes that have been stored in the storage spaces for a seedling-growing period a grain crops back to the first conveying track; and
an irrigating/draining/fertilizing unit, which is installed downstream the seedling-growing/warehousing unit and in a space where sunlight sufficient to growth of the grain crops is available, wherein the irrigating/draining/fertilizing unit has a cyclical conveying track and a traversing-type wagon, so that the culture boxes that have passed the seedling-growing period and sent on the first conveying track by the seedling-growing/warehousing unit are transferred to the cyclical conveying track that cyclically conveys the culture boxes thereon, and the irrigating/draining/fertilizing unit further comprises a watering/fertilizing device for watering and fertilizing the culturing soil in the culture boxes, thereby accomplishing a complete crop-cultivating activity of the grain crops.

7. The apparatus of claim 6, further comprising a harvesting unit that sends the culture boxes that have undergone operation of the irrigating/draining/fertilizing unit back to the first conveying track, and to a joint between the first conveying track and a second conveying trac, wherein a threshing device is provide at one side of the joint for tilting the culture boxes that come from the first conveying track and has accomplished the crop-cultivating activity toward the threshing device, so that the threshing device threshes grains from the harvestable grain crops, thereby completing a harvesting activity, after which the culture boxes are laced on the second conveying track and moved toward the input end of the first conveying track, thereby forming an apparatus for cyclical cultivation and harvesting of the grain crops.

8. The apparatus of claim 7, wherein the harvesting unit further comprises:
a workbench, which is provided with a plurality of balls so that the culture boxes are allowed to slide thereon;
a plurality of culture box manipulators, for cyclically operating on the workbench, wherein each of the culture box manipulators comprises:
a bottom shell;
a top plate, which has a projection area in a top-view plane that is equal to a projection area of the bottom shell in the top-view plane, and is slightly larger than a projection area of the culture boxes in the top-view plane, wherein the top plate has an upper plane for carrying a said culture box, and the top plate has a left lateral thereof hinged to one lateral of the bottom shell;
a pair of claiming jaws, which are installed at the left lateral and a right lateral of the top plate, respectively, and operatably close to hold the culture box therebetween; and
an air cylinder, which has two ends thereof hinged to the right lateral of the top plate and an opposite lateral of the bottom shell, and when operating makes the top plate and the bottom shell rotate with respect to each other against where they are hinged;
a machine-controlled arm complex, which comprises a plurality of machine-controlled arms, for moving the culture boxes from the first conveying track to corresponding cultivation box manipulators on the workbench, moving the culture box manipulators to predetermined locations on the workbench, and moving the culture boxes the cultivation box manipulators to the second conveying track;
at least one threshing device, which is installed at one side of the workbench, and rotates to removes the grains from the grain crops in the tilted culture box; and
a cutter, which is located at the side of the workbench having the at least one threshing device, and serves to cut stems and leaves of the thrashed grain crops,
wherein, when the claiming jaws clamp the culture box, the air cylinder stretches to rotate the top plate with respect to the bottom shell so as to tilt the culture box; and when the grain crops in the culture box have been cut off, the air cylinder retracts to rotate the top plate and lay the top plate on the bottom shell, after which the claiming jaws release the culture box.

9. The apparatus of claim 7, further comprising a soil treating unit that is located downstream the harvesting unit and has a soil-ripping/root-removing device and a sterilizing/weeding device, so that for the culture boxes fed from the second conveying track, the soil-ripping/root-removing device rips and loosens the culture soil in the culture boxes, and removes roots of the grain crops and weeds, and the sterilizing/weeding device sterilizes and fertilizes the culture soil, after which the culture boxes are transferred to the first conveying track of the conveying unit and moved toward the input end.

10. The apparatus of claim 9, further comprising a liquid-fertilizer fermenting unit that is located downstream the soil treating unit and has a shredder and a liquid-fertilizer fermenting tank, so that the stems and leaves of the grain crops cut off by the harvesting unit and the roots of the grain crops and the weeds removed by the soil treating unit are shredded into fine pieces by the shredder and the fine pieces are fermented in the liquid-fertilizer fermenting tank to produce a liquid fertilizer for the soil treating unit and the irrigating/draining/fertilizing unit to use.

11. The apparatus of claim 6, wherein the first conveying track and the second conveying track each comprise a plurality of column-like rollers parallel to each other, so that when rolling the column-like rollers drives predetermined square base plates to move; and
each said culture box has a bottom whose two sides are each provided with an underlaying square tube, and three said culture boxes are gathered as a set to be placed on a said square base plate to be moved;
each said culture box being formed with a drain hole that is located between the two underlaying square tubes; the drain hole being removably plugged and sealed by a drain stopper below the culture box; the cyclical conveying track comprising a plurality of column-like rollers parallel to each other, and the column-like rollers rolling and driving the culture box to move; a drainage controller being installed among the column-like rollers; and the drainage controller using an extendable crook to detachably connect the drain stopper.

12. The apparatus of claim 6, wherein the sowing unit further comprises:
a leveler, which uses a first robotic arm to control a leveling board to traverse across the fertilized and not sowed culture soil in the culture boxes on the first conveying track, so as to level the surface of the soil;
a grain depot, which is used to store the seeds of the grain crops;
a broadcaster, which is installed downstream the leveler in an advancing direction of the first conveying track, and has a plurality of low-pressure suction tubes arranged into an array, wherein each of the low-pressure suction tubes draws a said seed of the grain crops with a negative pressure, and ejects the seed when negative pressure is replaced by a positive pressure;
a second robotic arm, which is connected to the broadcaster top control the broadcaster to move between the grain depot and the culture boxes, so that the broadcaster broadcast the seeds of the grain crops at predetermined locations in the culture boxes;
a coverer, which is installed downstream the broadcaster in the advancing direction of the first conveying track, and serves to cover the seeds broadcasted in the culture boxes with the culture soil; and
a waterer, which is installed downstream the coverer in the advancing direction of the first conveying track, and serves to apply water into the culture boxes to keep the culture soil humid; in which
the seedling-growing/warehousing unit further comprises a sprayer configured to stretch into each of the storage spaces to water the culture boxes stored in the storage spaces so as to satisfy a minimum water requirement that supports a seedling-growing activity of the grain crops.

13. The apparatus of claim 6, wherein the watering/fertilizing device of the irrigating/draining/fertilizing unit further comprises:
a fertilizing module, comprising:
a liquid-fertilizer storage tank, for storing a liquid fertilizer;
a first water-pumping motor;
a first pipe, which is connected to the first water-pumping motor, so that the first water-pumping motor activates to pump a liquid fertilizer stored in the liquid-fertilizer storage tank into the first pipe; and
a plurality of liquid-fertilizer nozzles, which are connected to the first pipe for spraying the liquid fertilizer;
a water-spraying module, which comprises:
a clean-water tank, for storing clean water;
a second water-pumping motor;
a second pipe, which is connected to the second water-pumping motor, so that the second water-pumping motor activates to pump clean water in the clean-water tank into the second pipe; and
a plurality of clean-water nozzles, which are connected to the second pipe for spraying the clean water;
a fixed frame, which has an upper shelf and a lower shelf, so that the liquid-fertilizer nozzles are arranged along the upper shelf, and the clean-water nozzles are arranged along the lower shelf; and
a displacer, which carries the fixed frame and is located at one end of the cyclical conveying track, so that when a said culture box is delivered to a place in front of the watering/fertilizing device by the cyclical conveying track, the displacer approaches the culture box, and the first water-pumping motor operates to spray the liquid fertilizer over leaves of the grain crops through the liquid-fertilizer nozzles, and the second water-pumping motor operates to spray the clean water to roots of the grain crops through the clean-water nozzles, wherein after the leaves are watered and to soil is fertilized, the displacer returns to a home position thereof, leaving the culture box cyclically moving on the cyclical conveying track.

14. The apparatus of claim 6, further comprising a canopying unit, which canopies the cyclical conveying track from above, and serves to unroll a rain cover in case of heavy rain so as to protect grains on the grain crops from direct rain hits;
wherein the canopying unit further comprises:
a plurality of arch-like ribs, which span over the cyclical conveying track;
a rain-cover roll, which contains a rain cover that is rolled up, wherein the rain cover is normally rolled up and is unrolled to slidably spread over the arch-like ribs when receiving an external pulling force, and when the pulling force disappears, the rain-cover roll rolls the rain cover back to enclosure thereof;
a guiding steel wire, which has one end thereof tied on a terminal of the rain cover, and is unwound and slidably spreads over the arch-like ribs; and
a wire winch, which is connected to an opposite end of the guiding steel wire so as to wind the guiding steel wire and unroll the rain cover.

15. The apparatus of claim 9, wherein the soil treating unit further comprises:
a plurality of soil-ripping/root-removing devices, each comprising:
two rotary rakes, each formed by a rotating shaft and a plurality of spikes perpendicularly combined to the rotating shaft; and
two controlling motors, each connected to the rotating shaft of a said rotary rake and configured to rotate oppositely and synchronously, so as to pose the two rotary rakes in a contracted state where the spikes are opposite and parallel to each other; in an expanded state where the spikes are parallel to each other and all pointed downward; or a root-removing state where the spikes are staggered with an angular difference that is smaller than or equal to 90 degrees; and
a third robotic arm, which is connected to and controls the soil-ripping/root-removing devices to perform following operations:
moving the soil-ripping/root-removing devices from a root-removing area to a location over the culture boxes in which the grain crops have been cut off;
posing the soil-ripping/root-removing devices into the expanded state, and pressing the soil-ripping/root-removing devices down to the culture soil in the culture boxes;
posing the soil-ripping/root-removing devices into the root-removing state, and lifting the soil-ripping/root-removing devices upward so that remaining roots of the grain crops are grasped and held between by the spikes of the two rotary rakes; and
moving the soil-ripping/root-removing devices back to a location over the root-removing area, and posing the soil-ripping/root-removing devices into the expanded state again so that the remaining roots of the grain crops fall into the root-removing area;
a steam-based sterilizing/weeding device, which is installed over the second conveying track, and comprises:
a plurality of steaming stirring rods, each comprising a first tube and a plurality of steaming/stirring blades fixedly connected to one end of the first tube, wherein each said first tube has a support ring at a middle part thereof and each said steaming/stirring blade defines therein an air-guiding pipe that is communicated with the first tube, so that when the first tube is filled with steam, the steam flows out through the air-guiding pipe;
a first transmission box, which encloses an opposite end of each of the first tubes and contains therein a first transmission mechanism and at least one drive motor that drives the first transmission mechanism to operate to rotate the steaming stirring rods synchronously;
three fixing plates, each having a profile matching a top opening of a said culture box and being provided with a plurality of round holes, wherein a said first tube is inserted into a said round hole, so that each of the fixing plates is supported by the support rings;
a steam generator, which is mounted on the first transmission box and connected to the first tubes through a connecting pipe, and serves to generate and deliver the steam to the first tubes; and
a first lifting device, which is connected between the first transmission box and a bracket or a ceiling board for adjusting the first transmission box in altitude,
wherein when the three culture boxes are moved to a location below the steam-based sterilizing/weeding device by the second conveying track, the first lifting device lowers the first transmission box in altitude, so that the steaming/stirring blades of the steaming stirring rods insert into the culture soil in the culture boxes in a manner that each of the fixing plate covers the top opening of the corresponding culture box, after which the steam generator and the at least one drive motor start to operate and the steaming stirring rods rotate, so that the steam flowing out of the air-guiding pipes kills bacteria and weeds in the culture soil and accomplishes a sterilization and weeding activity; and upon completion of the sterilization and weeding activity, the steam generator and the at least one drive motor stop, and the first lifting device lifts the first transmission box in altitude, thereby removing the steaming/stirring blades of the steaming stirring rods from the culture soil to allow the culture boxes to resume advancing as the second conveying track is activated.

16. The apparatus of claim 9, wherein the soil treating unit further comprises a liquid-fertilizer applicator, which is installed over the second conveying track, and comprises:
a plurality of fertilizer dispensing rod, each comprising a second tube and a plurality of liquid-fertilizer stirring blades fixedly connected to one end of the second tube, wherein each said liquid-fertilizer stirring blade contains therein a liquid-guiding pipe that is communicated with the second tube, so that when the second tube is filled with a liquid fertilizer, the liquid fertilizer flows out through the liquid-guiding pipe;
a second transmission box, which enclose an opposite end of each of the second tubes, and the second transmission box contains therein a second transmission mechanism and at least one drive motor that drives the second transmission mechanism to operate to rotate the fertilizer dispensing rods synchronously;
a fertilizer dispenser, which is mounted on the second transmission box and is connected to the second tubes through a connecting pipe for delivering the liquid fertilizer to the second tubes; and
a second lifting device, which is connected between the second transmission box and a bracket or a ceiling board for adjusting the second transmission box in altitude,
wherein when the three culture boxes are moved to a location below the liquid-fertilizer applicator by the second conveying track, the second lifting device lowers the second transmission box in altitude, so that the liquid-fertilizer stirring blades of the fertilizer dispensing rods insert into the culture soil in the culture boxes after which the fertilizer dispenser and the at least one drive motor start to operate and the fertilizer dispensing rods rotate, so that the liquid fertilizer flowing out of the liquid-guiding pipes fertilizes the culture soil and accomplishes a fertilization activity; and upon completion of the fertilization activity, the fertilizer dispenser and the at least one drive motor stop, and the second lifting device lifts the second transmission box in altitude, thereby removing the liquid-fertilizer stirring blades of the fertilizer dispensing rods from the culture soil to allow the culture boxes to resume advancing as the second conveying track is activated.
